(19) United States
(12) Patent Application Publication
(10) Pub. No.: US 2015/0234458 A1
(43) Pub. Date: Aug. 20, 2015

(54) HEAD-UP DISPLAY

(71) Applicants: Chi-Tang Hsieh, Hsin-Chu (TW); Chung-Ting Wei, Hsin-Chu (TW); Hsin-Wen Tsai, Hsin-Chu (TW)

(72) Inventors: Chi-Tang Hsieh, Hsin-Chu (TW); Chung-Ting Wei, Hsin-Chu (TW); Hsin-Wen Tsai, Hsin-Chu (TW)

(73) Assignee: CORETRONIC CORPORATION, Hsin-Chu (TW)

(21) Appl. No.: 14/507,841

(22) Filed: Oct. 7, 2014

(30) Foreign Application Priority Data
Feb. 20, 2014 (TW) 103105732

(51) Int. Cl. G06F 3/01; B60R 1/00; G02B 27/01

(52) U.S. Cl. CPC G06F 3/013; G02B 27/0172; B60R 1/00; G06F 3/017

(57) ABSTRACT

A head-up display including a display panel, a non-mechanical focusing lens, and a determining unit is provided. The display panel is configured to emit an image beam. The non-mechanical focusing lens is disposed on a transmission path of the image beam and generates an image of the image beam. The determining unit is electrically connected to the non-mechanical focusing lens and configured to adjust a focal length of the non-mechanical focusing lens according to a sensing signal, so as to change an image distance from the image to a user's eye.

### CROSS-REFERENCE TO RELATED APPLICATION

This application claims the priority benefit of Taiwan application serial no. 103105732, filed on Feb. 20, 2014. The entirety of the above-mentioned patent application is hereby incorporated by reference herein and made a part of this specification.

### BACKGROUND OF THE INVENTION

1. Field of the Invention

The invention relates to a display, and more particularly, to a head-up display.

2. Description of Related Art

In modern society, requirements for vehicles include not only those for the vehicles' performance, and attention has also begun to be paid to the vehicles' interior and safety equipments. With the help of technology products nowadays (e.g. in-car voice navigation system, voice-based collision warning system, etc.), the incidence of accidents caused by drivers in states such as long-time drowsy driving, distracted and so on has indeed dropped. In the meantime, however, since a non-voice information display apparatus is generally mounted on a dashboard, when the driver lowers their head to watch the apparatus, driving safety is likely to be affected.

A head-up display (HUD) displays the information desired by the driver in front of the driver, so that the driver does not have to lower or turn their head distractedly, which thus enhances driving safety. Nonetheless, while driving a car, the driver focuses their eye at different distances at different car speeds. In general, in high-speed driving (e.g. driving on a highway), the driver focuses their eye at a further distance in front of the car; in low-speed driving (e.g. driving in an urban area), the driver has their eye on road conditions within a shorter distance in front of the car. However, in the current head-up display, an image distance between an image generated by the head-up display and the driver's eye is fixed. Accordingly, whether in high-speed or low-speed driving, if the driver intends to view the information shown by the head-up display, they have to spend time focusing their eye at the image distance at which the image is located. Such time for focusing the eye delays the time that the driver notices the road conditions in front of the car.

U.S. Pat. No. 6,014,259 discloses a zoom lens including a liquid lens, wherein a focal length of the zoom lens is variable by changing a shape of the liquid lens. U.S. Pat. No. 7,126,583 discloses adjustment of a head-up display. U.S. Pat. No. 8,031,406 discloses a head-up display for vehicle.

### SUMMARY OF THE INVENTION

The invention provides a head-up display, the head-up display being capable of adjusting an image distance from an image generated by the head-up display to a user's eye, thereby enabling the user to more quickly focus their eye on information displayed on the head-up display.

Other objectives and advantages of the invention are further illustrated by the technical features disclosed in the invention.

To achieve one of, a part of or all of the above objectives or other objectives, an embodiment of the invention provides a head-up display including a display panel, a non-mechanical focusing lens and a determining unit. The display panel is configured to emit an image beam. The non-mechanical focusing lens is disposed on a transmission path of the image beam and generates an image from the image beam. The determining unit is electrically connected to the non-mechanical focusing lens and configured to adjust a focal length of the non-mechanical focusing lens according to a sensing signal, so as to change an image distance from the image to an eye of a user.

In an embodiment of the invention, the non-mechanical focusing lens includes a focal-length-changeable lens electrically connected to the determining unit and disposed on the transmission path of the image beam, wherein the focal-length-changeable lens is a liquid lens or a liquid crystal lens.

In an embodiment of the invention, the non-mechanical focusing lens includes a focal-length-changeable lens array electrically connected to the determining unit and disposed on the transmission path of the image beam, wherein the focal-length-changeable lens array is a liquid lens array or a liquid crystal lens array.

In an embodiment of the invention, the non-mechanical focusing lens further includes at least one fixed-focus optical device disposed on the transmission path of the image beam.

In an embodiment of the invention, the determining unit is configured to be electrically connected to a speedometer of a car, the sensing signal is a car speed signal from the speedometer, and the determining unit is configured to adjust the focal length of the non-mechanical focusing lens according to the car speed signal from the speedometer. When the speed of the car is a first speed, the non-mechanical focusing lens adjusts the image distance to a first numerical value. When the speed of the car is a second speed, the non-mechanical focusing lens adjusts the image distance to a second numerical value, wherein the first speed is lower than the second speed, and the first numerical value is smaller than the second numerical value.

In an embodiment of the invention, when the speed of the car increases from the first speed toward the second speed, the image distance increases from the first numerical value toward the second numerical value. When the speed of the car decreases from the second speed toward the first speed, the image distance decreases from the second numerical value toward the first numerical value.

In an embodiment of the invention, the head-up display further includes an eyeball tracking apparatus electrically connected to the determining unit, wherein the sensing signal is an image signal from the eyeball tracking apparatus. The eyeball tracking apparatus is configured to track an eyeball of the user, wherein the determining unit is configured to determine a direction change of the eyeball of the user according to the image signal. When the determining unit determines that the eyeball of the user looks down, the non-mechanical focusing lens adjusts the image distance to the first numerical value. When the determining unit determines that the eyeball of the user looks forward, the non-mechanical focusing lens adjusts the image distance to the second numerical value, wherein the first numerical value is smaller than the second numerical value.

In an embodiment of the invention, when the eyeball rotates from downward to upward, the image distance gradually increases; when the eyeball rotates from upward to downward, the image distance gradually decreases.

In an embodiment of the invention, the head-up display further includes a user interface electrically connected to the determining unit, wherein the sensing signal is an operation signal from the user interface. The determining unit is configured to adjust the focal length of the non-mechanical focusing lens according to the user's operation on the user interface.

In an embodiment of the invention, the head-up display further includes a combiner disposed on the transmission path of the image beam from the non-mechanical focusing lens, wherein the combiner reflects at least a portion of the image beam to the eye of the user.

The embodiments of the invention achieve at least one of the following advantages or effects. The head-up display of the embodiments of the invention includes the non-mechanical focusing lens, and the determining unit adjusts the focal length of the non-mechanical focusing lens according to the sensing signal, so as to change the image distance from the image on the display panel to the user's eye. Therefore, the time for focusing the user's eye on the image is reduced, thus improving driving safety. In addition, due to the employment of the non-mechanical focusing lens for adjusting the focal length, the adjustment time for the focal length is shorter. Moreover, vibration and noise are suppressed during the focusing, and sway of the car during travel has less influence on the effect of the focusing. Thus, the lens is enhanced in reliability and life span.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B are schematic diagrams of structures of a head-up display according to an embodiment of the invention at two different image distances.

FIG. 2A and FIG. 2B are schematic diagrams of structures of a head-up display according to another embodiment of the invention at two different image distances.

FIG. 3A and FIG. 3B are schematic diagrams of structures of a head-up display according to still another embodiment of the invention at two different image distances.

FIG. 4 is a schematic diagram of a structure of a head-up display according to yet still another embodiment of the invention.

FIG. 5 is a schematic diagram of a structure of a head-up display according to yet still another embodiment of the invention.

FIG. 6 is a schematic diagram of a structure of a head-up display according to yet still another embodiment of the invention.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

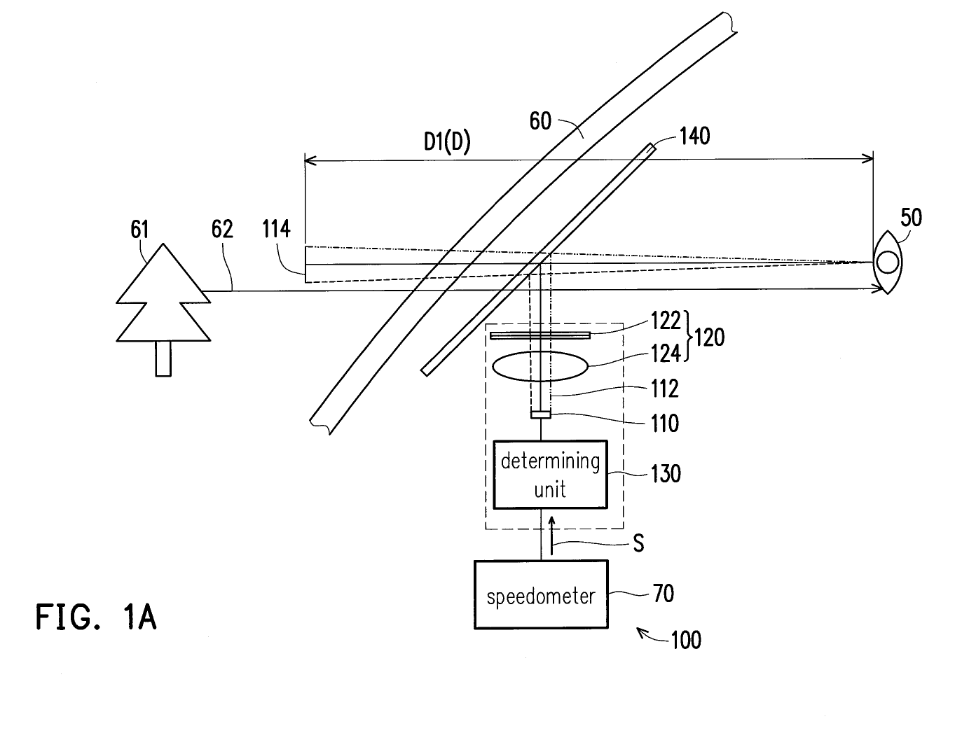

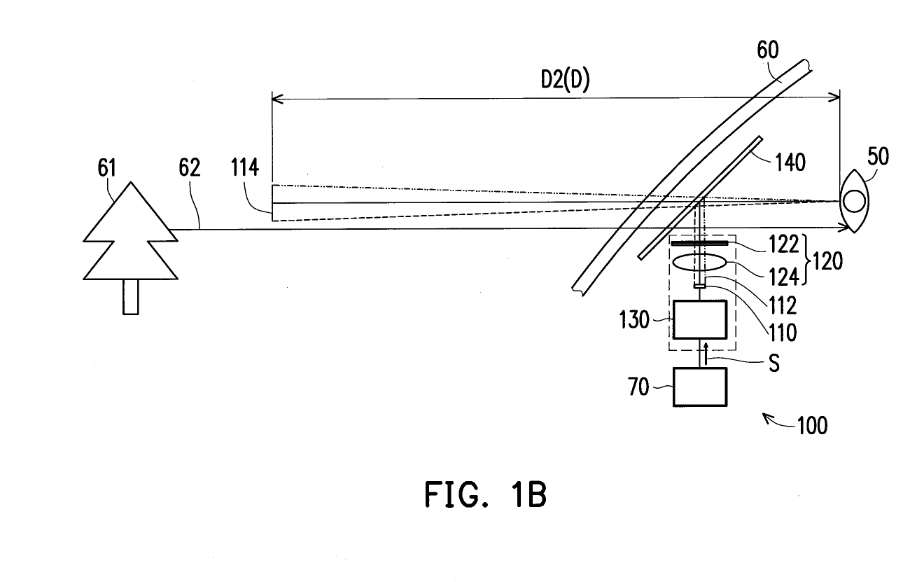

FIG. 1A and FIG. 1B are schematic diagrams of structures of a head-up display according to an embodiment of the invention at two different image distances. Referring to FIG. 1A and FIG. 1B, a head-up display 100 of the embodiment includes a display panel 110, a non-mechanical focusing lens 120 and a determining unit 130. The display panel 110 is configured to emit an image beam 112. In the embodiment, the display panel 110 is, for example, a liquid crystal display panel, an organic light-emitting diode display panel, a light-emitting diode display panel, a plasma display panel or any other suitable display panel. The non-mechanical focusing lens 120 is disposed on a transmission path of the image beam 112 and generates an image 114 from the image beam 112.

In the embodiment, the head-up display 100 further includes a combiner 140 disposed on the transmission path of the image beam 112 from the non-mechanical focusing lens 120. The combiner 140 reflects at least a portion of the image beam 112 to a user's eye 50 in a driver's seat of a car, and the combiner 140 allows a light 62 from a windshield 60 of the car to pass therethrough to be transmitted to the user's eye 50. For example, the light 62 emitted from a background object 61 in front of the windshield 60 of the car is transmitted to the user's eye 50 through the windshield 60 and the combiner 140 in sequence. In the embodiment, the combiner 140 is a partially transmissive, partially reflective mirror, such as a transflective mirror. In addition, the combiner 140 has optical magnification capability. However, the invention is not limited thereto. In the embodiment, the head-up display 100 is disposed between a dashboard and the windshield 60 of the car, or at least a portion of the head-up display 100 is embedded at the rear of the dashboard.

The determining unit 130 is electrically connected to the non-mechanical focusing lens 120, and is configured to adjust a focal length of the non-mechanical focusing lens 120 according to a sensing signal S, so as to change an image distance D from the image 114 to the user's eye 50.

In an embodiment, the non-mechanical focusing lens 120 includes a focal-length-changeable lens 122 electrically connected to the determining unit 130 and disposed on the transmission path of the image beam 112, wherein the focal-length-changeable lens 122 is a liquid lens or a liquid crystal lens. The liquid lens is, for example, a dielectric liquid lens, and droplet deformation of the liquid lens is controlled by means of voltage, thereby changing a curvature of a lens surface to achieve a focusing effect. The dielectric liquid lens has a colorless transparent silicone oil (dimethylsiloxane) structure, and the silicone oil is packaged in an immiscible alcohol solution. However, the invention is not limited thereto. Moreover, a material of the liquid crystal lens is, for example, nematic liquid crystal (NLC). The NLC is a liquid composed of elongated or disc-shaped molecules. The liquid crystal lens is driven during powered on, and a driving signal may be fine-tuned to create an electric field strength that generates a desired refractive index gradient as well as a desired optical refractive index. In addition, the alignment of the NLC molecules may be changed by adjusting a frequency of an electric signal. Nonetheless, the invention is not limited thereto.

In another embodiment, the non-mechanical focusing lens 120 further includes a fixed-focus optical device 124 (FIG. 1A shows an invariable-focus lens 124 as an example) disposed on the transmission path of the image beam 112, wherein the fixed-focus optical device 124 is a refractive lens or a reflective mirror. In the embodiment, the fixed-focus optical device 124 is disposed between the focal-length-changeable lens 122 and the display panel 110. However, in other embodiments, the focal-length-changeable lens 122 may be disposed between the fixed-focus optical device 124 and the display panel 110.

In the embodiment, the determining unit 130 is configured to be electrically connected to a speedometer 70 of a car, and the sensing signal S is a car speed signal from the speedometer 70. For example, the speedometer 70 is configured to measure a rotational speed of wheels of the car, and then convert the rotational speed into a speed of the car. The determining unit 130 is configured to adjust the focal length of the non-mechanical focusing lens 120 according to the car speed signal from the speedometer 70. When the speed of the car is at a first speed, the non-mechanical focusing lens 120 adjusts the image distance D to a first numerical value D1 (as shown in FIG. 1A). When the speed of the car is at a second speed, the non-mechanical focusing lens 120 adjusts the image distance D to a second numerical value D2 (as shown in FIG. 1B), wherein the first speed is lower than the second speed, and the first numerical value D1 is smaller than the second numerical value D2. In the embodiment, when the speed of the car increases from the first speed toward the second speed, the image distance D increases from the first numerical value D1 toward the second numerical value D2. When the speed of the car decreases from the second speed toward the first speed, the image distance D decreases from the second numerical value D2 toward the first numerical value D1.

In an embodiment, the fixed-focus optical device 124 has a focal length of 400 mm, and the focal-length-changeable lens 122 has a variable focal length from 425 mm to infinity. When the focal-length-changeable lens 122 has an infinite focal length, the optical effect of the focal-length-changeable lens 122 is equivalent to that of a plate glass. At this moment, the focal length of the entire non-mechanical focusing lens 120 is equal to the focal length of the fixed-focus optical device 124, which is 400 mm, and the resulting image distance D is 1.46 m. Here, the image 114 is located not far from the windshield 60. When the focal-length-changeable lens 122 has a focal length of 425 mm, the focal length of the entire non-mechanical focusing lens 120 is, for example, 208 mm, and the resulting image distance D is 10 m. Here, the image 114 is located far away in front of the car. For example, since the focal length of the focal-length-changeable lens 122 is adjustable between 425 mm and infinity, the resulting image distance D may be continuously adjusted between 1.46 to 10 m. Nonetheless, the embodiment is provided for exemplary purposes only but is not intended to limit the invention.

The head-up display 100 of the embodiment includes the non-mechanical focusing lens 120, and the determining unit 130 adjusts the focal length of the non-mechanical focusing lens 120 according to the sensing signal S, so as to change the image distance D from the image 114 on the display panel 110 to the user's eye 50. Accordingly, the time for focusing the user's eye 50 on the image 114 is reduced, thus improving driving safety. In addition, due to the employment of the non-mechanical focusing lens 120 for adjusting the focal length, the adjustment time for the focal length is shorter (e.g., less than 1 second, which is shorter than the time spent by a mechanical apparatus). Moreover, vibration and noise are suppressed during the focusing, and sway of the car during driving has less influence on the effect of the focusing, and therefore the lens is enhanced in reliability and life span. Another advantage of employing the liquid lens or liquid crystal lens is that a focusing range may be continuous, i.e. the image distance D is continuously adjustable. Hence, there is no need to dispose two or more head-up displays having different image distances in the car. Accordingly, the structure of the head-up display 100 of the embodiment occupies less space in the car.

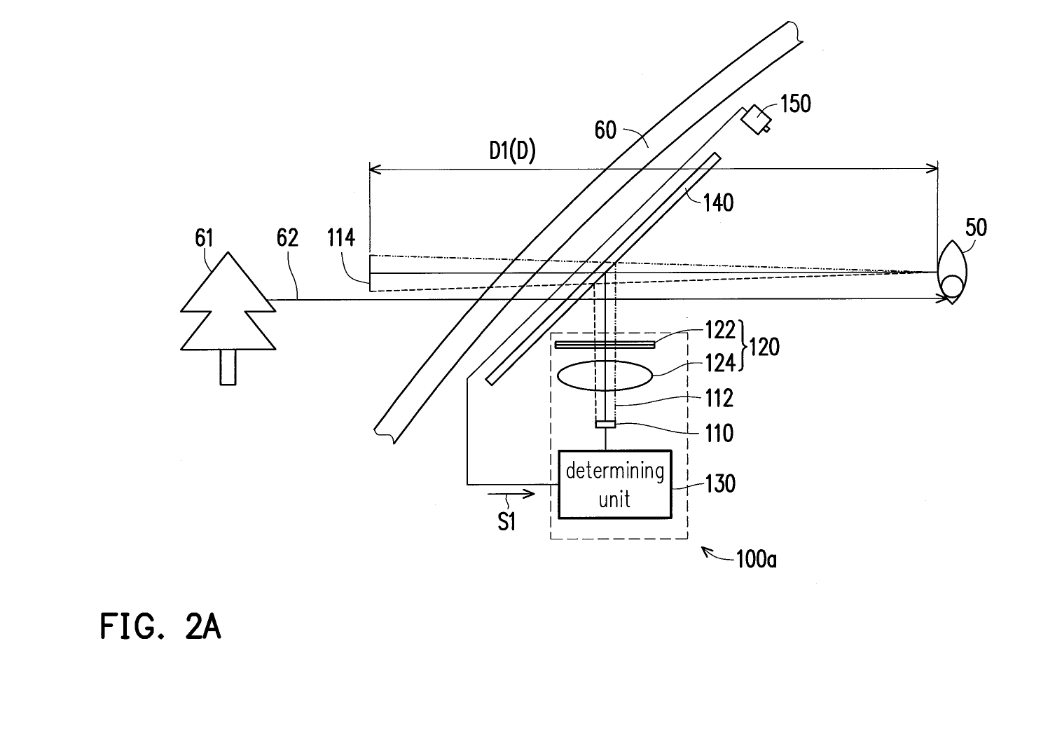

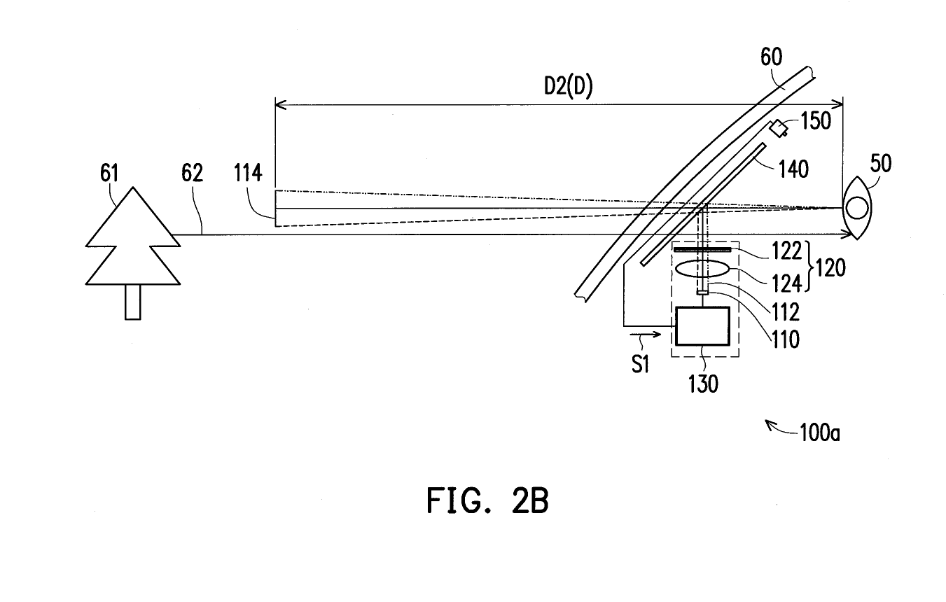

FIG. 2A and FIG. 2B are schematic diagrams of structures of a head-up display according to another embodiment of the invention at two different image distances. Referring to FIG. 2A and FIG. 2B, a head-up display 100a of the embodiment is similar to the head-up display 100 in FIG. 1A and FIG. 1B, and the difference is mainly described in the following respects. In the embodiment, the head-up display 100a further includes an eyeball tracking apparatus 150, for example, a video camera 150 as shown in FIG. 2A and FIG. 2B. The eyeball tracking apparatus 150 is electrically connected to the determining unit 130, wherein a sensing signal S1 is an image signal from the eyeball tracking apparatus 150, and the eyeball tracking apparatus 150 is configured to track an eyeball of the user's eye 50 in the driving seat of the car. The determining unit 130 is configured to determine a direction change of the user's eyeball according to the image signal (i.e. the sensing signal S1). When the determining unit 130 determines that the user's eyeball looks down, the non-mechanical focusing lens 120 adjusts the image distance D to the first numerical value D1. When the determining unit 130 determines that the user's eyeball looks forward, the non-mechanical focusing lens 120 adjusts the image distance D to the second numerical value D2, wherein the first numerical value D1 is smaller than the second numerical value D2. Such design is on the following basis: the user's eyeball looks down usually when viewing a near road condition at a lower car speed, and thus a shorter image distance D (such as the image distance D having the first numerical value D1) is employed. In another respect, the user's eyeball looks forward usually when viewing a distant road condition at a higher car speed, and thus a longer image distance D (such as the image distance D having the second numerical value D2) is employed. In addition, in the embodiment, when the user's eyeball rotates from downward to upward, the image distance D gradually increases; when the user's eyeball rotates from upward to downward, the image distance D gradually decreases.

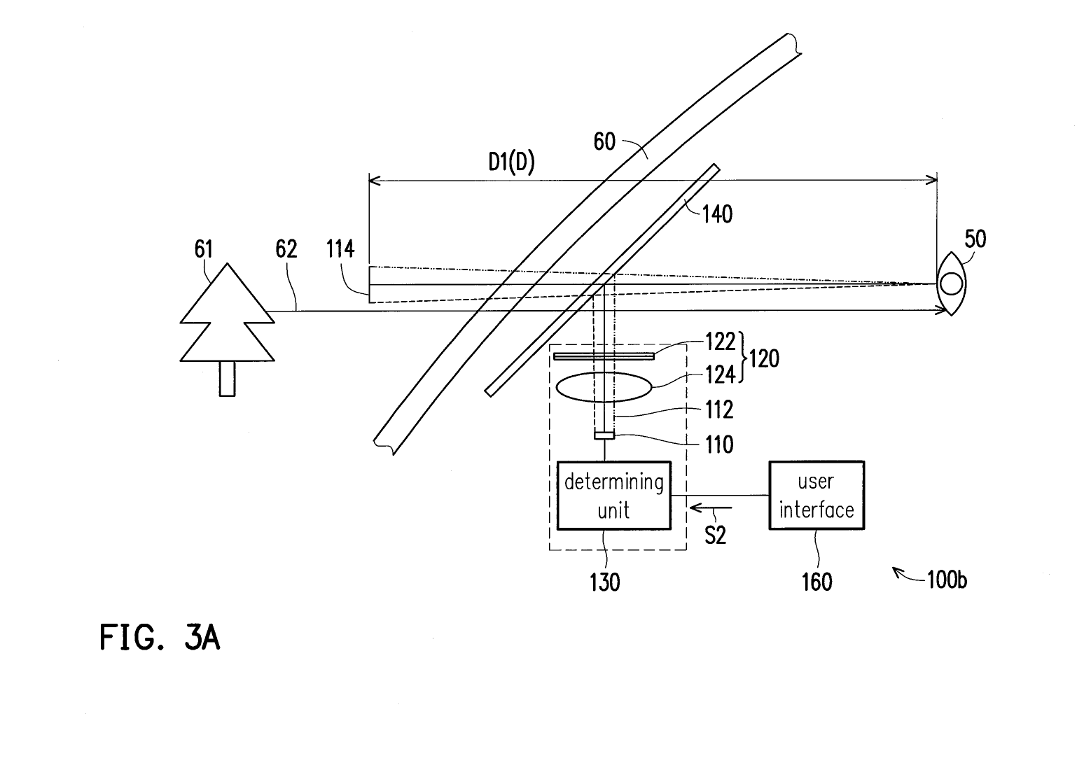

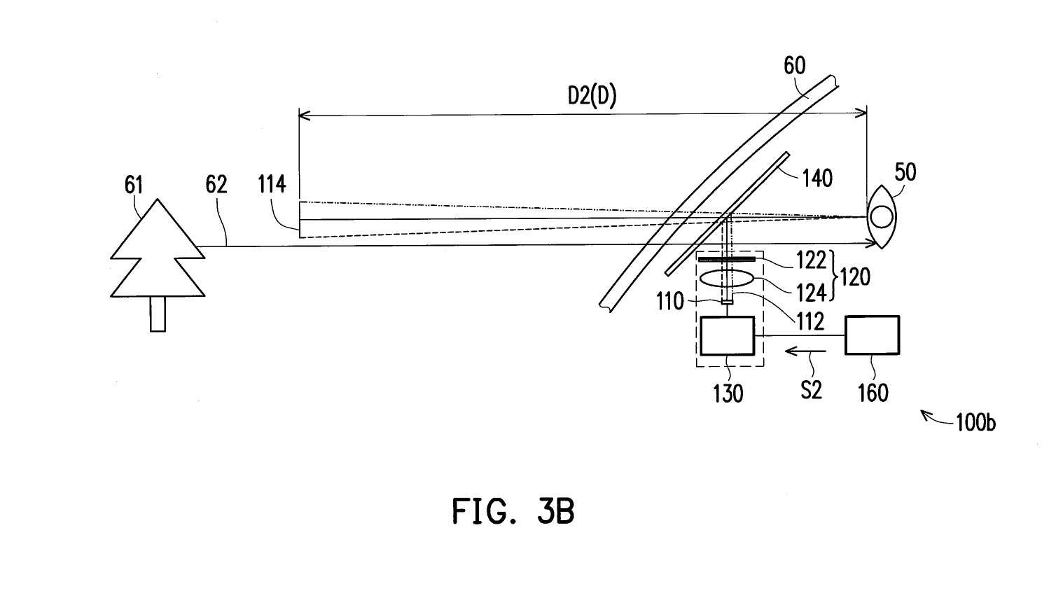

FIG. 3A and FIG. 3B are schematic diagrams of structures of a head-up display according to still another embodiment of the invention at two different image distances. Referring to FIG. 3A and FIG. 3B, a head-up display 100b of the embodiment is similar to the head-up display 100 in FIG. 1A and FIG. 1B, and the difference is mainly described in the following respects. In the embodiment, the head-up display 100b further includes a user interface 160 electrically connected to the determining unit 130, wherein a sensing signal S2 is an operation signal from the user interface 160. The determining unit 130 is configured to adjust the focal length of the non-mechanical focusing lens 120 according to the user's operation on the user interface 160. In other words, the user decide themselves through the operation on the user interface 160 whether the numerical value of the accustomed image distance D is the first numerical value D1, the second numerical value D2 or any other numerical value between the first numerical value D1 and the second numerical value D2. The user interface 160 is, for example, a touch panel, a button, a knob or any other appropriate device that may be operated by the user.

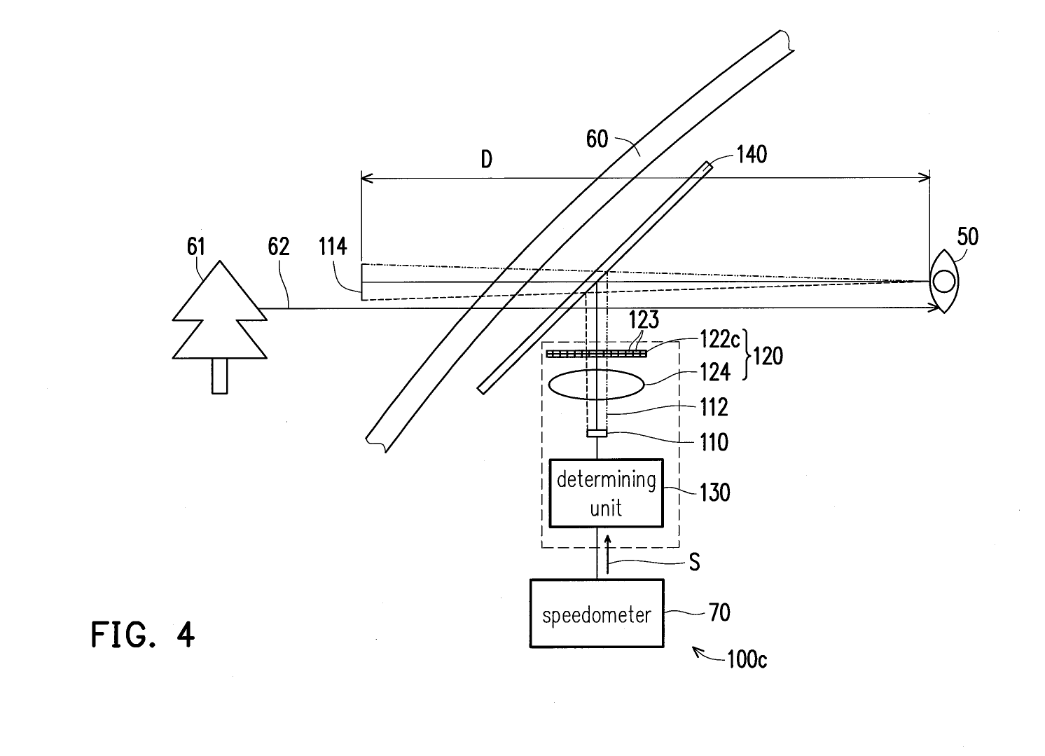

FIG. 4 is a schematic diagram of a structure of a head-up display according to yet still another embodiment of the invention. Referring to FIG. 4, a head-up display 100c of the embodiment is similar to the head-up display 100 in FIG. 1A and FIG. 1B, and the difference is mainly described in the following respects. In the head-up display 100c of the embodiment, the focal-length-changeable lens 122 in FIG. 1A is displaced by a focal-length-changeable lens array 122c. The focal-length-changeable lens array 122c is disposed on the transmission path of the image beam 112, wherein the focal-length-changeable lens array 122c is, for example, a liquid lens array or a liquid crystal lens array, and the focal-length-changeable lens array 122c includes a plurality of variable-focus microlenses 123 arranged in a two-dimensional array.

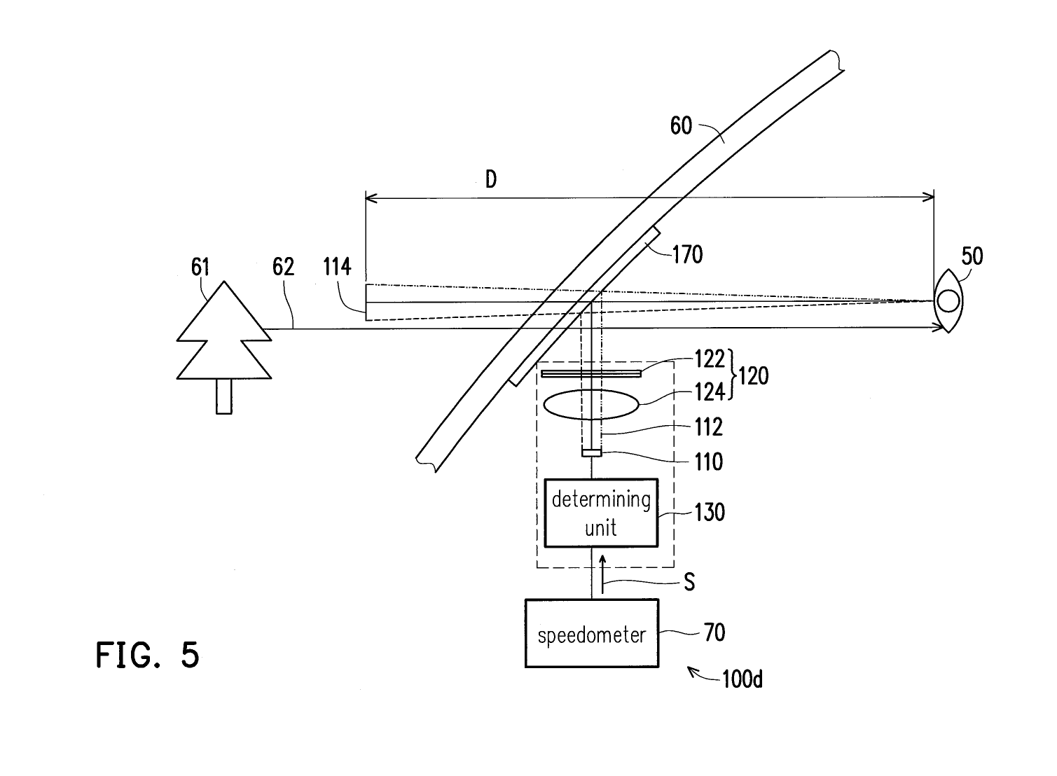

FIG. 5 is a schematic diagram of a structure of a head-up display according to yet still another embodiment of the invention. Referring to FIG. 5, a head-up display 100d of the embodiment is similar to the head-up display 100 in FIG. 1A and FIG. 1B, and the difference is mainly described in the following respects. The head-up display 100d does not include the combiner 140 that is separated from the windshield 60 as shown in FIG. 1A. The non-mechanical focusing lens 120 projects the image beam 112 onto the windshield 60. In the embodiment, an optical film 170 is adhered to the windshield 60. The optical film 170 reflects at least a portion of the image beam 112 to the user's eye 50, and allows the light 62 from the windshield 60 to pass through the optical film 170 to the user's eye 50. In the embodiment, the optical film 170 is a partially transmissive, partially reflective film, such as a transflective film.

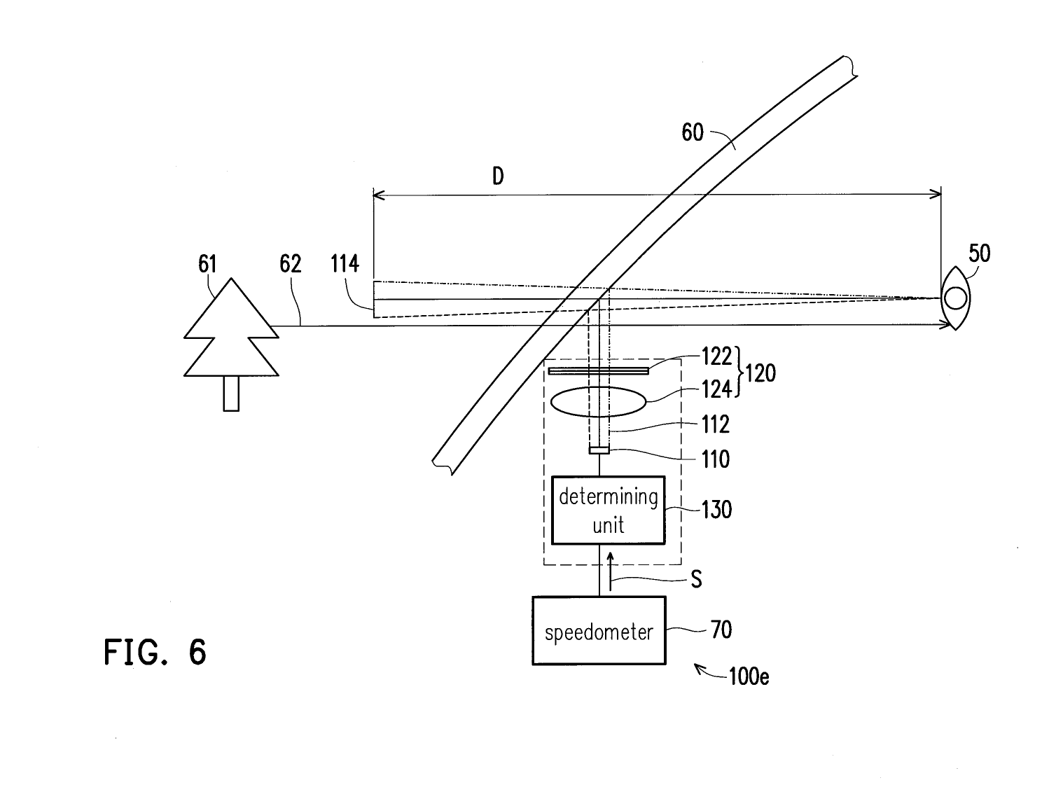

In another embodiment, as shown in FIG. 6, a head-up display 100e does not employ the optical film 170, the non-mechanical focusing lens 120 projects the image beam 112 directly onto the windshield 60, and the windshield 60 reflects at least a portion of the image beam 112 to the user's eye 50.

In summary, the embodiments of the invention achieve at least one of the following advantages or effects. The head-up display of the embodiments of the invention includes the non-mechanical focusing lens, and the determining unit adjusts the focal length of the non-mechanical focusing lens according to the sensing signal, so as to change the image distance from the image on the display panel to the user's eye. Therefore, the time for focusing the user's eye on the image is reduced, thus improving driving safety. In addition, due to the employment of the non-mechanical focusing lens for adjusting the focal length, the adjustment time for the focal length is shorter. Moreover, vibration and noise are suppressed during the focusing, and sway of the car during travel has less influence on the effect of the focusing, and therefore the lens is enhanced in reliability and life span.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A head-up display, comprising:
a display panel configured to emit an image beam;
a non-mechanical focusing lens disposed on a transmission path of the image beam and generating an image from the image beam; and
a determining unit electrically connected to the non-mechanical focusing lens and configured to adjust a focal length of the non-mechanical focusing lens according to a sensing signal, so as to change an image distance from the image to an eye of a user.

2. The head-up display as claimed in claim 1, wherein the non-mechanical focusing lens comprises a focal-length-changeable lens electrically connected to the determining unit and disposed on the transmission path of the image beam, wherein the focal-length-changeable lens is a liquid lens or a liquid crystal lens.

3. The head-up display as claimed in claim 2, wherein the non-mechanical focusing lens comprises a focal-length-changeable lens array electrically connected to the determining unit and disposed on the transmission path of the image beam, wherein the focal-length-changeable lens array is a liquid lens array or a liquid crystal lens array.

4. The head-up display as claimed in claim 2, wherein the non-mechanical focusing lens further comprises at least one fixed-focus optical device disposed on the transmission path of the image beam.

5. The head-up display as claimed in claim 1, wherein the determining unit is configured to be electrically connected to a speedometer of a car, the sensing signal is a car speed signal from the speedometer, and the determining unit is configured to adjust the focal length of the non-mechanical focusing lens according to the car speed signal from the speedometer; when a speed of the car is at a first speed, the non-mechanical focusing lens adjusts the image distance to a first numerical value; and when the speed of the car is at a second speed, the non-mechanical focusing lens adjusts the image distance to a second numerical value, wherein the first speed is lower than the second speed, and the first numerical value is smaller than the second numerical value.

6. The head-up display as claimed in claim 5, wherein when the speed of the car increases from the first speed toward the second speed, the image distance increases from the first numerical value toward the second numerical value; and when the speed of the car decreases from the second speed toward the first speed, the image distance decreases from the second numerical value toward the first numerical value.

7. The head-up display as claimed in claim 1, further comprising an eyeball tracking apparatus electrically connected to the determining unit, wherein the sensing signal is an image signal from the eyeball tracking apparatus, and the eyeball tracking apparatus is configured to track an eyeball of the user, wherein the determining unit is configured to determine a direction change of the user's eyeball according to the image signal; when the determining unit determines that the user's eyeball looks down, the non-mechanical focusing lens adjusts the image distance to a first numerical value; and when the determining unit determines that the user's eyeball looks forward, the non-mechanical focusing lens adjusts the image distance to a second numerical value, wherein the first numerical value is smaller than the second numerical value.

8. The head-up display as claimed in claim 7, wherein when the eyeball rotates from downward to upward, the image distance gradually increases, and when the eyeball rotates from upward to downward, the image distance gradually decreases.

9. The head-up display as claimed in claim 1, further comprising a user interface electrically connected to the determining unit, wherein the sensing signal is an operation signal from the user interface, and the determining unit is configured to adjust the focal length of the non-mechanical focusing lens according to the user's operation on the user interface.

10. The head-up display as claimed in claim 1, further comprising a combiner disposed on the transmission path of the image beam from the non-mechanical focusing lens, wherein the combiner reflects at least a portion of the image beam to the user's eye.
